(19) United States
(12) Patent Application Publication
(10) Pub. No.: US 2009/0066623 A1
(43) Pub. Date: Mar. 12, 2009

(54) COLOR SEQUENTIAL LIQUID CRYSTAL DISPLAY AND METHOD OF DRIVING THE SAME

(75) Inventors: Mei-sheng Ma, Hsin-Chu City (TW); Hsueh-ying Huang, Hsin-Chu City (TW)

Correspondence Address: KIRTON AND MCCONKIE, 60 EAST SOUTH TEMPLE,, SUITE 1800, SALT LAKE CITY, UT, 84111, US

(73) Assignee: AU OPTRONICS CORP., Hsin-Chu (TW)

(21) Appl. No.: 12/124,932

(22) Filed: May 21, 2008

(30) Foreign Application Priority Data
Sep. 11, 2007 (TW) 096133881

(51) Int. Cl. G09G 3/36

(52) U.S. Cl. 345/89; 345/102

(57) ABSTRACT

A color sequential liquid crystal display (LCD) and a method of driving the same are introduced herein. The method is implemented to change transmittance of a liquid crystal display (LCD) panel by inserting a pre-driving signal between two adjacent frames. The pre-driving signal can be adjusted by the gray level difference of the adjacent frames. The method is capable of not only improving accuracy of the color mixing of the color sequential liquid crystal display (LCD), but also resolving the prior art problem of uneven pixel displays resulted from the time difference of activating different gate line in sequences in the liquid crystal display (LCD) panel.

### FIELD OF THE INVENTION

The present invention relates to a color sequential liquid crystal display (LCD) and a method of driving the same, and more particularly to a color sequential liquid crystal display (LCD) and a method of driving the same, which is capable of raising an accuracy of a color dithering of a color sequential liquid crystal display (LCD).

### BACKGROUND OF THE INVENTION

A conventional thin film transistor liquid crystal display (TFT-LCD) utilizes red, green, and blue (RGB) primary color filters with illumination of a white backlight source to effect a chromatic expression. Differently, a color sequential liquid crystal display utilizes red, green, and blue (RGB) primary light sources, free of color filter, to illuminate in turn for the same frame period. Based on the visual persistence phenomenon for human eyes, the three primaries are processed by additive color mixing to effect a chromatic expression.

A liquid crystal display (LCD) comprises a liquid crystal display (LCD) panel having a plurality of pixels in array. Each pixel has an upper and lower electrodes. Data signals are inputted into the electrodes for controlling brightness of respective primary lights passed through the pixels and thus varying a mixing primary light ratio to show various colors with different shades and tones.

In another aspect, since the color sequential liquid crystal (LC) panel for displaying color images utilizes monochrome liquid crystal cells and RGB primary backlight sources to perform continuous additive color mixings at an instant when the human eyes' resolution ability is restricted, the color filters are needless therefor.

In implementation, the color sequential liquid crystal display (LCD) technology leans on a response rate of liquid crystal molecules, extremely. For each pixel, the three primary lights are cycled in time sequences. In order to mix the needed colors, transmittance of liquid crystals must comply with a gamma curve when each of the three-primary backlight is turned on. A response rate of Twisted Nematic Liquid Crystals (TNLC) can reach more than 10 ms, and especially in a gray-to-gray status reaches up to 40 ms. In the color sequential liquid crystal display (LCD) panel, the response time of liquid crystals is too slow so that it causes not only delay of dynamic images but also RGB primary mixing errors. Although a black frame insertion (BFI) method is adopted to accelerate response rate of liquid crystals, a response time of liquid crystal molecule from different gray level to the black insertion is inconsistent so that some gray levels can not reach a required transmittance under black frame insertion. Uncertain transmittance would not insure the liquid crystal response in the next frame. This may lead the liquid crystal alignment not to be predictable therefore. It means that a gray-to-brightness ratio of liquid crystals would become uncertain. As the result, it is hard to accurately control the colors mixing so that the displayed colors are unstable.

Therefore, the present invention sets forth a color sequential liquid crystal display (LCD) and a method of driving the same, which raising an accuracy of color mixing in the color sequential liquid crystal display (LCD).

### SUMMARY OF THE INVENTION

An objective of the present invention is to provide a color sequential liquid crystal display (LCD) and a method of driving the same which is capable of improving the color dithering resulted from liquid crystal (LC) response time of the color sequential liquid crystal display (LCD).

Another objective of the present invention is to provide a color sequential liquid crystal display (LCD) and a method of driving the same, which is capable of resolving the problem of the pixel displaying non-uniformity resulted from the initial time difference of activating different gate lines in sequences in a liquid crystal display (LCD) panel.

The method of driving the color sequential liquid crystal display (LCD) according to the invention comprises steps as described below.

In step 1, an image data comparing unit receives a gray level of a present frame.

In step 2, the image data comparing unit receives a gray level of a next frame.

In step 3, a pre-driving frame is inserted between the present frame and the next frame.

In step 4, the image data comparing unit compares the gray levels between the present and next frames, and outputs a pre-driving signal to an image data controlling device after looking up a predetermined pre-driving lookup table for changing transmittance of a corresponding liquid crystal pixel in the liquid crystal display (LCD) panel.

The color sequential liquid crystal display (LCD) according to the invention comprises a liquid crystal display (LCD) panel, a backlight device, an image data comparing unit, and an image data controlling device. The image data comparing unit is used for receiving image data of a present frame and image data of a next frame, and outputting a pre-driving signal to the image data controlling device after looking up a predetermined pre-driving lookup table. The image data controlling device outputs the pre-driving signal to the liquid crystal display (LCD) panel and the backlight device for controlling transmittance of the liquid crystal display (LCD) panel at this time.

The color sequential liquid crystal display (LCD) and the method of driving the same according to the present invention changes transmittance of a liquid crystal display (LCD) panel by inserting a pre-driving signal between two adjacent frames. The pre-driving signal is determined by the gray level difference of the adjacent frames. The color sequential liquid crystal display (LCD) and the method are capable of not only improving the color dithering resulted from liquid crystal (LC) response time, but also resolving the problem of the pixel displaying non-uniformity resulted from the initial time difference of activating different gate lines in sequences in the liquid crystal display (LCD) panel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a structural diagram of a color sequential liquid crystal display (LCD) according to a preferred embodiment of the present invention;

FIG. 2 is a waveform diagram which depicts comparison between different optical responses with pre-driving signals and without pre-driving signal;

FIG. 3 is a driving waveform diagram in implementation of a driving method according to a preferred embodiment of the present invention;

FIG. 4A illustrates transmittance changes when transformations among different gray levels from 160 to 255 are inserted by different pre-driving signals;

FIG. 4B illustrates transmittance changes when transformations among different gray levels from 255 to 160 are inserted by different pre-driving signals;

FIG. 5 is a waveform diagram showing an exemplar of inserting different pre-driving signals into different gate line divisions; and

FIG. 6 is a flow chart of a method of driving a color sequential liquid crystal display (LCD) according to the present invention.

### DETAILED DESCRIPTION OF THE PREFERRED EMBODIMENTS

The present invention will be described in detail in conjunction with the appending drawings.

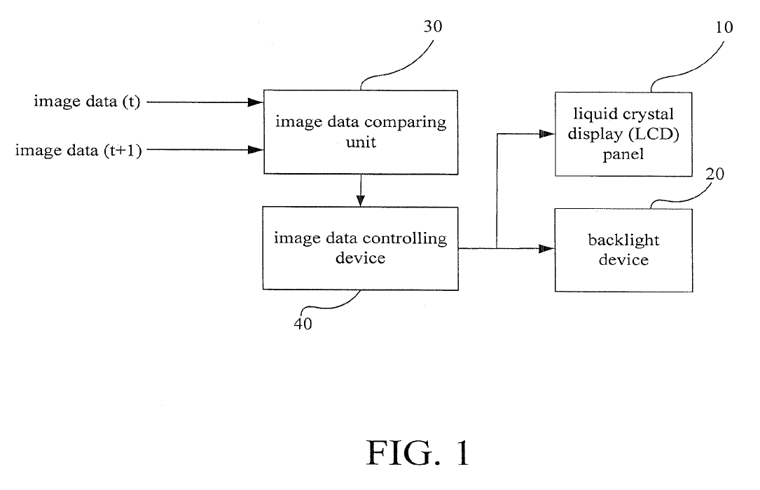

FIG. 1 is a structural diagram of a color sequential liquid crystal display (LCD) according to a preferred embodiment of the present invention. The color sequential liquid crystal display (LCD) comprises a liquid crystal display (LCD) panel 10, a backlight device 20, an image data comparing unit 30, and an image data controlling device 40. The liquid crystal display (LCD) panel 10 has liquid crystals and pixel arrays which are activated by an applied voltage to control transmittance of liquid crystals. Based on data signals, the liquid crystal display (LCD) panel 10 applies different voltages to control the brightness of backlight passing through the liquid crystals for displaying different image pixels. The backlight device 20 supplies necessary backlight for the liquid crystal display (LCD) panel 10 displaying images. The backlight device 20 provides at least three primary light sources. The three-primary light sources, based on each sub-frame divided from each frame, are illuminated by respectively turning on the three-primary light source in predetermined sequences. The image data controlling device 40 is used for controlling timing sequences and periods of each frame and each sub-frame, and synchronously inputting corresponding scanning signals and the transformed data signals to the liquid crystal display (LCD) panel 10 in compliance with turn-on and turn-off of each primary light. Under the sub-frames using different primary lights, the image data controlling device 40 also sequentially applies voltages to pixel electrodes of the liquid crystal display (LCD) panel 10 to adjust gray-to-brightness ratios of liquid crystals. Thus, the brightness passed through the pixel arrays can be controlled sufficiently for displaying correct gray level so as to constitute images on the pixel arrays. The above-mentioned gray-to-brightness ratio (as a transmittance) complies with a transmittance defined by a gamma curve. The image data comparing unit 30 is used for receiving a gray image data (t) in a present frame and a gray image data (t+1) in a next frame, and outputting a pre-driving signal to the image data controlling device 40 after looking up a predetermined pre-driving lookup table. Then the image data controlling device 40 outputs the pre-driving signal to the liquid crystal display (LCD) panel 10 and the backlight device 20 for controlling transmittance.

TABLE 1

| Gray level | Transmittance (%) |
|---|---|
| 0 | 0% |
| 32 | 1% |
| 64 | 3% |
| 96 | 9% |
| 128 | 18% |
| 160 | 31% |
| 192 | 49% |
| 224 | 72% |
| 255 | 100% |

For example, table 1 shows an exemplar of relationships among gray levels and transmittances but not therefore limits the scope claimed by the present invention. The relationships between gray levels and transmittances can be adjusted on different demands. Each gray level is corresponding with a transmittance. Pre-determined transmittance of each gray level can be fixed. In a preferred embodiment, a period of each frame is 5.5 ms, and backlight is turned on for 3.5 ms. In the period when the backlight is turned on, gray level of the inputted pixels must be equaled to the transmittance corresponding to the gray level. In other words, response of liquid crystal must reach pre-determined transmittance of pixel data of a present frame before backlight is turned on.

TABLE 2

| | | Gray level of a present frame | | | | | | | | |
|---|---|---|---|---|---|---|---|---|---|---|
| | | 0 | 32 | 64 | 96 | 128 | 160 | 192 | 224 | 255 |
| Gray level of a next frame | 0 | | 1.95 | 1.75 | 1.68 | 1.65 | 1.65 | 1.68 | 1.74 | 2.58 |
| | 32 | 4.28 | | 2.59 | 2.38 | 2.31 | 2.30 | 2.35 | 2.51 | 3.50 |
| | 64 | 6.08 | 5.80 | | 3.50 | 3.54 | 3.54 | 3.63 | 3.86 | 6.62 |
| | 96 | 6.58 | 6.12 | 6.07 | | 4.17 | 4.32 | 4.50 | 4.88 | 8.50 |
| | 128 | 7.28 | 6.80 | 6.52 | 6.35 | | 5.02 | 5.80 | 6.73 | 11.53 |
| | 160 | 8.60 | 7.79 | 7.39 | 7.07 | 6.88 | | 7.76 | 8.27 | 13.83 |
| | 192 | 9.50 | 8.90 | 8.58 | 8.40 | 8.42 | 8.25 | | 11.70 | 17.66 |
| | 224 | 10.65 | 9.96 | 9.68 | 9.63 | 9.68 | 9.90 | 10.29 | | 22.63 |
| | 255 | 6.00 | 6.07 | 5.23 | 5.03 | 4.81 | 4.77 | 4.68 | 4.76 | |

Table 2 shows response time (0%˜90%) of liquid crystals from gray level to gray level (unit: ms). As shown in table 2, liquid crystals with different response rates have individual response time within different gray-to-gray transformations. Some gray-to-gray response time exceed a period of a frame (for example, 5.5 ms), and accordingly transmittance of pixels can not reach a gray-to-brightness ratio which is required by the gray level for the turn-on period of the backlight. To overcome the problem, a method according to the present invention includes a step of inserting a pre-driving frame between two adjacent gate scanning by inputting a pre-charged data according to the two gray levels of the present and next frames. Thus, the gray level inputted to the next frame can reach a required transmittance when backlight is turned on. The corresponding pre-driving signal can be used to pretest the liquid crystal display (LCD) panel 10, and then record the result in the image data controlling device 40.

TABLE 3

| Data | | | | | | | |
|---|---|---|---|---|---|---|---|
| driving signal | | | | | | | |
| | gray | | | | | | |
| gray | level | | | | | | |
| level of | of | Response time of liquid crystal of each pre-driving signal | | | | | |
| present | next | (ms) | | | | | |
| frame | frame | L255 | L240 | L224 | L80 | L16 | L0 |
| 160 | 255 | 3.31 ms | 3.46 ms | 4.17 ms | 4.75 ms | 5.08 ms | 5.40 ms |
| 255 | 160 | 7.06 ms | 7.16 ms | 6.46 ms | 5.16 ms | 1.24 ms | 4.7 ms |

As the testing result of an example of response time of liquid crystals under different pre-driving signals (0%-90%) shown in table 3, assuming that gray level of the present frame is 160 and gray level of the next frame is 255, and then different pre-driving signals L255, L240, L224, L80, and L16 are respectively inserted between the present frame and the next frame. By observing liquid crystal response time from the present frame to the next frame, it is found that a liquid crystal response time of 3.31 ms is the shortest when inserting the pre-driving signal L255. It can reach the gray level 255 before backlight is turned on. Accordingly, the pre-driving signal L255 should be inserted into between the gray levels 160 and 255. On the contrary, if gray level of the present frame is 255 and gray level of the next frame is 160, and then different pre-driving signals L255, L240, L224, L80, and L16 are inserted between the present frame and the next frame. By observing liquid crystal response time from the present frame to the next frame, it is found that liquid crystal response time of 1.24 ms is the shortest when inserting the pre-driving signal L16. It can reach the gray level 160 before backlight is turned on. Accordingly, the pre-driving signal L16 should be inserted into between gray level 255 and gray level 160. Different pre-driving signals can induce liquid crystal to generate different transmittance. Driving liquid crystal molecules in advance can lead a frame of each pixel to reach a required gray level so as to raise accuracy of color mixing of the liquid crystal display (LCD) panel.

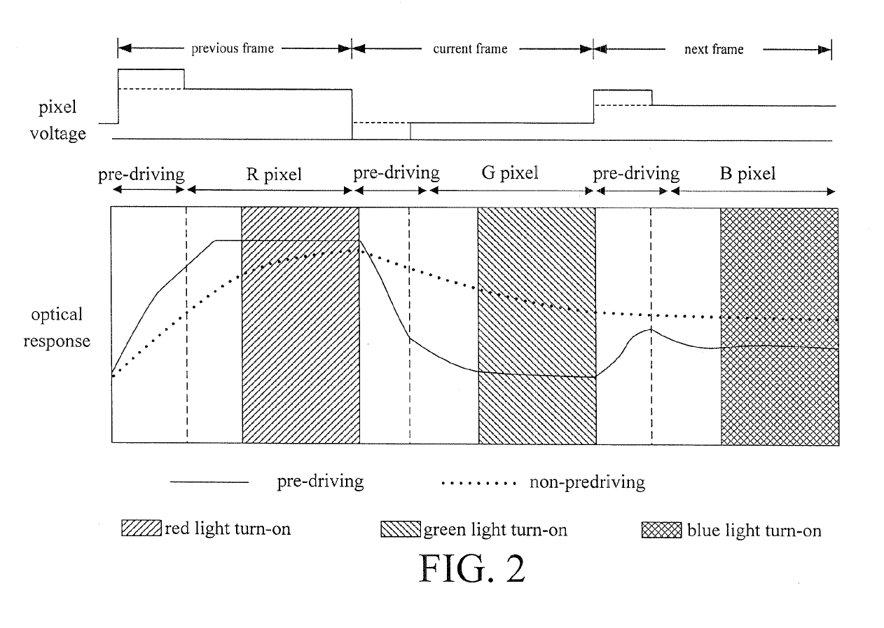

FIG. 2 is a waveform diagram which depicts comparison between different optical responses with pre-driving signals and without pre-driving signals. Clearly, the driving method of the present invention pre-changes transmittance of a liquid crystal display (LCD) by inserting the pre-driving signals, thus waveform changes representing the optical response are faster than that in the prior art. The waveform of optical response having pre-driving signals can shorten a response time when the liquid crystal display (LCD) panel switches between different transmittance of two adjacent frames. Accordingly, the color sequential liquid crystal display (LCD) of the present invention can reach better and more accurate color mixing in a shorter response time.

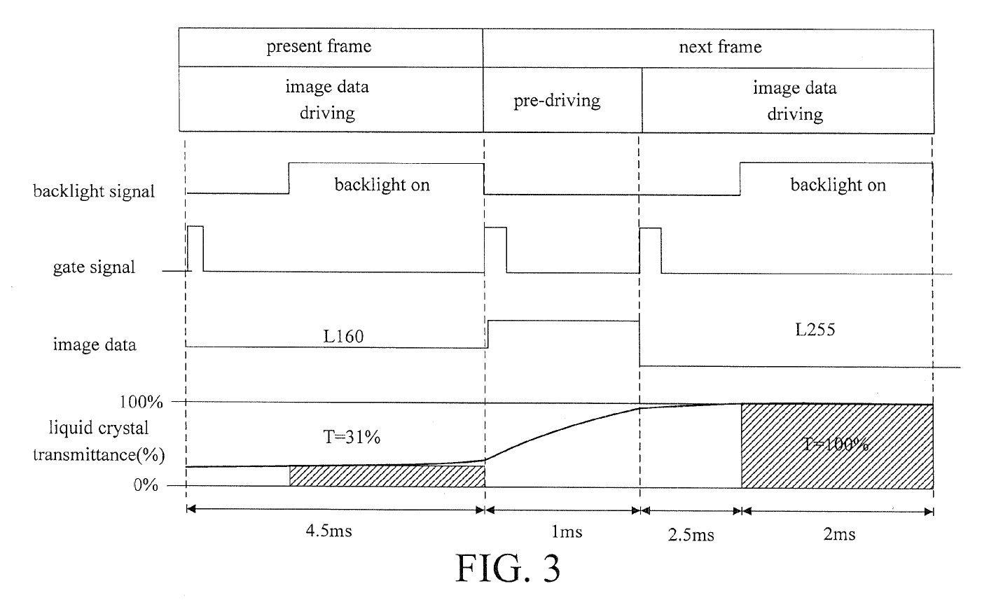

FIG. 3 is a driving waveform diagram in implementation of the driving method according to a preferred embodiment of the present invention. As shown in FIG. 3, when the gray level of the present frame is 160 and the gray level of the next frame is 255, a pre-driving signal L255 is inserted between the present frame and the next frame. It results a transmittance change of liquid crystals from transmittance 31% of the gray level 160 to transmittance 100% of the gray level 255 for a response time of 3.5 ms. Accordingly, the liquid crystals can reach a transmittance required by the gray level before backlight of the next frame is turned on. The color sequential liquid crystal display (LCD) also can reach a needed color mixing rate for the response time.

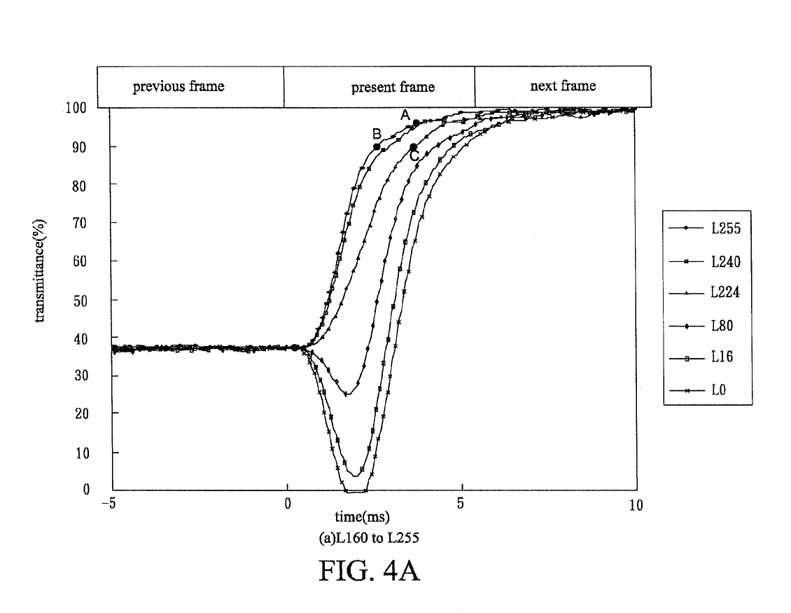

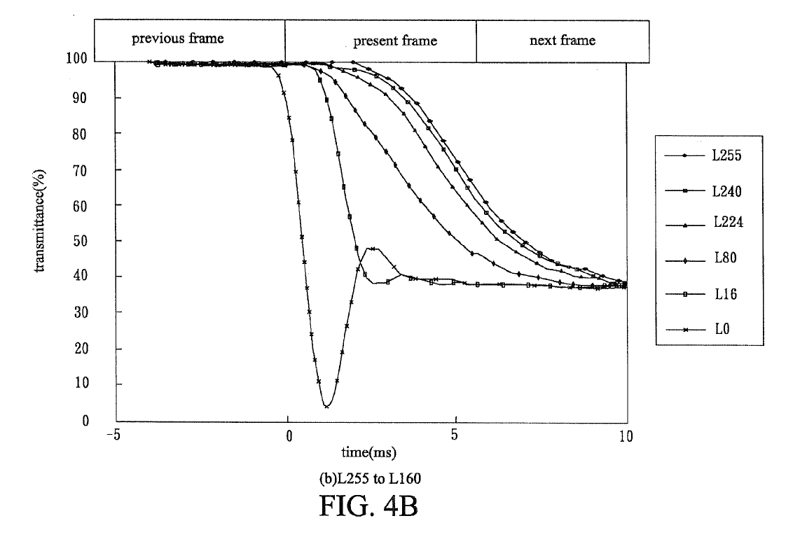

In another aspect, the method of driving the color sequential liquid crystal display (LCD) according to the present invention also can resolve the problem of the pixel displaying non-uniformity within the liquid crystal display (LCD) panel. Due to the initial time difference of turning on different gate lines in sequences, for example, an activation time difference from the 1st gate line to the 240th gate line is approximate 1 ms, so a problem of pixel displaying non-uniformity occurs in the liquid crystal display (LCD) panel. FIG. 4A illustrates transmittance changes between different gray levels from 160 to 255 when inserting different pre-driving signals therebetween. FIG. 4B illustrates transmittance changes between different gray levels from 255 to 160 when inserting different pre-driving signals therebetween. Please refer to FIG. 4A, if backlight is turned on in 3.5 ms, the activation time difference from the 1st gate line to the 240th gate line is 1 ms. That is, the liquid crystal response time of the pixels on the 1st gate line is 3.5 ms, and the liquid crystal response time of the pixels on the 240th gate line is 2.5 ms. When the backlight is turned on, the transmittance corresponding to the 1st gate line is 95% (as a ‘A’ point shown in FIG. 4A), and the transmittance corresponding the 240th gate line is 90% (as a ‘B’ point shown in FIG. 4A). To uniform transmittances of both, the 1st gate line should be inserted by a pre-driving signal L224 to change transmittances from point A to point C. (FIG. 4A) where the transmittances of the 1st gate line and the 240th gate line both are the same 90%. In practice, the gate lines could be divided into several divisions. From the 1st gate lines to the 120th gate lines are distributed into a first division, and from the 121st gate lines to the 240th gate lines are distributed into a second division. A pre-driving signal L230 (as achieved by an interpolation method) is inserted into the first division to induce transmittances from 80% to 85% within the first division. A pre-driving signal L255 is inserted into the second division to induce transmittance from 80% to 85% within the second division. The purpose is to reduce transmittance difference to reach a level where human eyes can not distinguish.

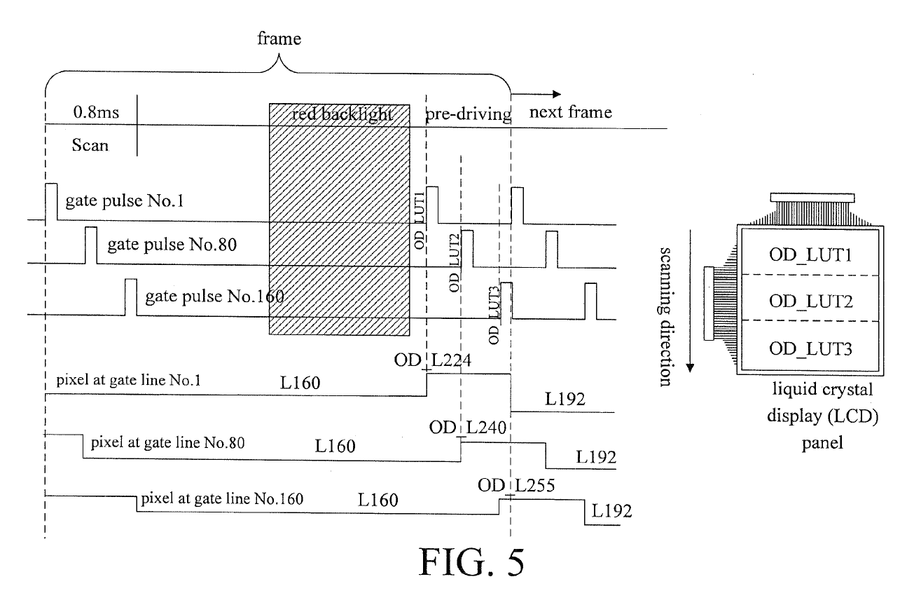

FIG. 5 is a waveform diagram showing an exemplar of inserting different pre-driving signals into different gate line divisions. In this exemplar, gate lines of a liquid crystal display (LCD) panel are divided into three divisions. Individual pre-driving signals are inserted into the three divisions. For example, from the 1st gate lines to the 79th gate lines are distributed into a first division, from 80th gate lines to the 159th gate lines are distributed into a second division, and from 160th gate lines to 240th gate lines are distributed into a third division. A pre-driving signal obtained from a lookup table OD_LUT1 is inserted into the first division, a pre-driving signal obtained from a lookup table OD_LUT2 is inserted into the second division, and a pre-driving signal obtained from a lookup table OD_LUT3 is inserted into the third division. When the gray level changes from the present frame to the next frame is from 160 to 192, the pre-driving signals L224, L240, and L255 are inserted into the first division, the second division and the third division, respectively. Accordingly, transmittances of the three divisions can tend to be the uniformity to withdraw the prior art problem of the pixel displaying non-uniformity resulted from the initial time difference of turning on different gate line divisions in sequences in the liquid crystal display (LCD) panel.

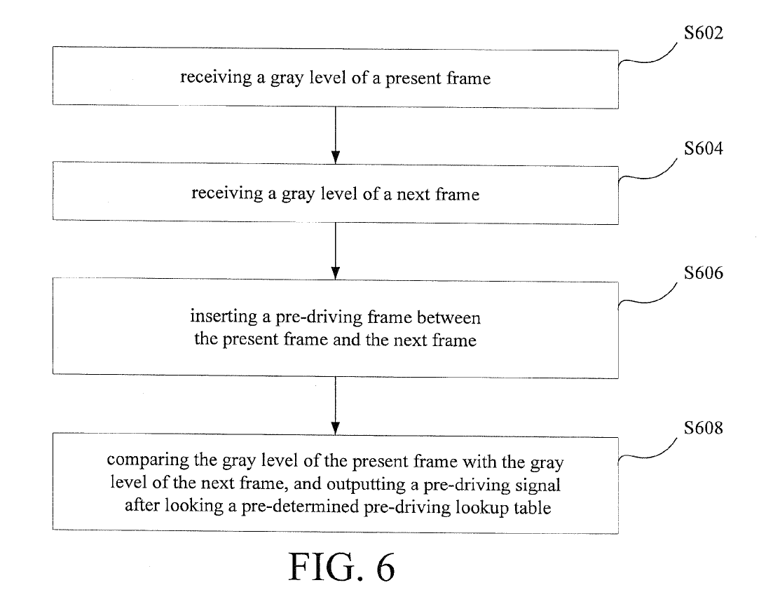

FIG. 6 is a flow chart of a method of driving a color sequential liquid crystal display (LCD) according to the present invention. First, referring to FIGS. 1 and 6, in step S602, the image data comparing unit 30 receives a gray level of a present frame (as an image data (t)). In step S604, the image data comparing unit 30 receives a gray level of a next frame (as an image data (t+1)). In step S606, a pre-driving frame is inserted between the present frame and the next frame. In step S608, the image data comparing unit 30 compares the gray level of the present frame with the gray level of the next frame, and outputs a pre-driving signal to the image data controlling device 40 after looking up a pre-determined pre-driving lookup table for changing transmittance of corresponding liquid crystals in the liquid crystal display (LCD) panel 10. In this embodiment, the pre-driving signal could be looked up upon a curve representing an optimized liquid crystal response referring to either the activation sequences of the different gate lines or occurrences between the gray level of the present frame and the gray level of the next frame. Thus, the liquid crystal response can reach a transmittance predetermined by the gray level of the present frame before backlights are turned on. In practice, the transmittance predetermined by the gray level of the present frame should comply with a transmittance defined by a gamma curve. In other application, the predetermined transmittance can be a fixed value.

In conclusion, the color sequential liquid crystal display (LCD) and the method of driving the same according to the present invention are capable of changing transmittance of a liquid crystal display (LCD) panel by inserting a pre-driving signal between two adjacent frames. Thus, the accuracy of color mixing of the color sequential liquid crystal display (LCD) is not only improved but also the problem of the pixel displaying non-uniformity resulted from the initial time difference of turning on different gate line in sequences in the liquid crystal display (LCD) panel is resolved.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method of driving a color sequential liquid crystal display, comprising the steps of:
receiving a gray level of a present frame;
receiving a gray level of a next frame;
inserting a pre-driving frame between the present frame and the next frame; and
comparing the gray level of the present frame with the gray level of the next frame, and outputting a pre-driving signal after looking up a predetermined pre-driving lookup table based on the comparison.

2. The method according to claim 1, wherein the predetermined pre-driving lookup table defines the pre-driving signal between the two gray levels.

3. The method according to claim 2, wherein the pre-driving signal is based on a curve corresponding to an optimized liquid crystal response occurring between the two gray levels, and the liquid crystal response reaches a transmittance predetermined by the gray level of the present frame before at least one backlight is turned on.

4. The method according to claim 3, wherein the transmittance predetermined by the gray level of the present frame complies with a transmittance defined by a gamma curve.

5. A method of driving a color sequential liquid crystal display, comprising:
receiving a gray level of a present frame;
receiving a gray level of a next frame;
inserting a pre-driving frame between the present frame and the next frame; and
outputting a pre-driving signal after looking up a predetermined pre-driving lookup table according to activation sequences of different gate lines in a liquid crystal display panel of the color sequential liquid crystal display.

6. The method according to claim 5, wherein the predetermined pre-driving lookup table defines the pre-driving signal corresponding to the activation sequences of different gate lines.

7. The method according to claim 5, wherein the pre-driving signal is based on a curve representing an optimized liquid crystal response referring to the activation sequences of the different gate lines of the liquid crystal display panel, and the liquid crystal response reach a transmittance predetermined by the gray level of the present frame before at least one backlight is turned on.

8. The method according to claim 5, wherein the transmittance pre-determined by the gray level of the present frame complies with a transmittance defined by the gamma curve.

9. A method of driving a color sequential liquid crystal display, the driving method comprising:
receiving a gray level of a present frame;
receiving a gray level of a next frame;
inserting a pre-driving frame between the present frame and the next frame; and
comparing the gray level of the present frame with the gray level of the next frame, and outputting a pre-driving signal after looking up a predetermined pre-driving lookup table according to activation sequences of different gate lines in a liquid crystal display panel of the color sequential liquid crystal display.

10. The method according to claim 9, wherein the predetermined pre-driving lookup table defines the pre-driving signal corresponding to the activation sequences of different gate lines and defines the pre-driving signal between the two gray levels.

11. The method according to claim 9, wherein the pre-driving signal is based on a curve representing an optimized liquid crystal response referring to either the activation sequences of the different gate lines or between the two gray levels, and the liquid crystal response reach a transmittance predetermined by the gray level of the present frame before at least one backlight is turned on.

12. The method according to claim 11, wherein the predetermined transmittance is a fixed value.

13. A color sequential liquid crystal display comprising:
a liquid crystal display panel having liquid crystal and pixel arrays, applying different voltages to control the brightness passing through liquid crystals according to data signals;
a backlight device having three-primary light sources, supplying necessary backlights for the liquid crystal display panel displaying images, wherein the three-primary light sources are switched in a predetermined sequence based on a sub-frame divided from at least one frame;
an image data controlling device controlling time sequences and periods of each sub-frame and each frame of the backlight device, and synchronously inputting corresponding scanning signals and the transformed data signals to the liquid crystal display panel according to switch of each primary light, and applying voltages to the liquid crystal display panel within the sub-frames with different primary lights to adjust transmittances of liquid crystals, for controlling the brightness passed through the pixel arrays to display correct gray level so as to constitute images in the pixel arrays; and
an image data comparing unit receiving two adjacent image data, getting a pre-driving signal after looking up a predetermined pre-driving lookup table according to the two adjacent image data, outputting the pre-driving signal to the image data controlling device, wherein the image data controlling device outputs the pre-driving signal to the liquid crystal display panel for controlling transmittance of the liquid crystal display panel.

14. The color sequential liquid crystal display according to claim 13, wherein the predetermined pre-driving lookup table defines the pre-driving signal between the two adjacent image data.

15. The color sequential liquid crystal display according to claim 14, wherein the pre-driving signal is based on a curve representing an optimized liquid crystal response occurring between the two adjacent image data, and the liquid crystal response reaches a transmittance predetermined by one of the two image data before backlights are turned on.

16. The color sequential liquid crystal display according to claim 13, wherein the predetermined pre-driving lookup table defines the pre-driving signal corresponding to activation sequences of different gate lines formed in the liquid crystal display panel and defines the pre-driving signal between the two adjacent image data.

17. The color sequential liquid crystal display according to claim 16, wherein the pre-driving signal is based on a curve representing an optimized liquid crystal response with reference to either the activation sequences of the different gate lines or between the two adjacent image data, and the liquid crystal response reaches a transmittance predetermined by one of the two image data before backlights are turned on.

18. The color sequential liquid crystal display according to claim 17, wherein the transmittance predetermined by one of the two image data complies with a transmittance defined by a gamma curve.
